(19) United States
(12) Patent Application Publication
(10) Pub. No.: US 2004/0050914 A1
(43) Pub. Date: Mar. 18, 2004

(54) Method and magnetic element for welding together workpieces such as pipe material

(76) Inventor: Teunis Monster, Strijen (NL)

Correspondence Address: Steven M Koehler, Westman Champlin & Kelly, Suite 1600- International Centre, 900 Second Avenue South, Minneapolis, MN, 55402-3319, US

(21) Appl. No.: 10/451,521

(22) PCT Filed: Dec. 20, 2001
(86) PCT No.: PCT/NL01/00931

(30) Foreign Application Priority Data
Dec. 21, 2000 (NL) 1016939

(51) Int. Cl. B23K 31/02

(52) U.S. Cl. 228/212; 228/44.5

(57) ABSTRACT

The invention relates to a method of welding together for example two pie pieces (1,3) having an advance opening. First of all, the first pipe (1) piece is magnetised by contacting the first pipe piece with a magnetic (1,2) element. Then a second pipe (B) piece is positioned with respect to the first pipe piece, such that the surfaces of the pipe pieces to be welded are facing each other. Said surfaces of the pipe pieces are then welded at least partially, whereafter the magnetic element is removed. According to the invention, the magnetic element is positioned between said surfaces of the first (A) and second pipe pieces which are interconnected by welding. The magnetic element covers only a part of said surfaces.

The present invention relates to a method for welding together a first and a second metal workpiece with an advance opening, comprising the following steps:

magnetising the first workpiece by contacting the first workpiece with a magnetic element,

positioning the second workpiece with respect to the first workpiece, such that the surfaces of the workpieces to be welded together will face each other,

welding together said surfaces of the workpieces at least partially, and

removing the magnetic element.

The invention also relates to a magnetic element that can be used in welding together a first and a second workpiece with an advance opening, including a carrier fitted with at least one magnet.

Such a method and such a magnetic element are known in various embodiments thereof. Examples can be found in FR-A-2 801 001, DE-C-196 07 229, JP-A-61229498 and JP-A-58218395.

With these known methods, the magnetic elements are placed in abutment with the outer sides of the workpieces and possibly fixed in position in order to position the workpieces correctly with respect to each other. The drawback of this method is that when the outer sides of the workpieces to be connected together exhibit fanciful shapes, positioning of the magnetic elements is difficult. In some cases it is even impossible to use the method, for example with bends, T-pieces, w.n.-flanges, reducers, etc.

The object of the invention is to provide a renewed method and magnetic element for welding together workpieces, such as pipe pieces.

In order to accomplish that objective, the method according to the invention is characterised in that the magnetic element is placed between said surfaces of the first and second workpieces, which are interconnected by welding, with the magnetic element only covering a part of said surfaces.

By placing the magnetic element between the surfaces that are to be welded together, the magnetic element is made entirely independent of the shape of the outer sides of the workpieces, which consequently may have any shape. If a magnetic element is used whose thickness corresponds at least substantially with the desired advance opening, said advance opening will be determined substantially automatically and precise operation will be possible. Since the magnetic element covers only a part of the surfaces to be welded together, the uncovered part can be utilised for interconnecting the workpieces at least partially.

Preferably, a provisional welded joint is formed between the first and the second workpiece after the second workpiece has been positioned with respect to the first workpiece, which magnetic element is removed before the final welded joint is formed.

In order to enable easy removal of the magnetic element after the provisional welded joint has been made, the advance opening is slightly widened before or after the provisional welded joint is made. Said widening or enlarging of the advance opening can take place by means of a wedge, for example, which is interposed between the two workpieces. If said enlarging of the advance opening takes place before the provisional welded joint has been made, the thickness of the magnetic element should preferably be selected smaller than the desired advance opening by a very small degree, for example by 0.1 mm.

In order to further prevent the workpieces from moving with respect to each other, at least one positioning element, such as a glueing clamp, can be attached to the first workpiece temporarily before or after said magnetisation for the purpose of correctly positioning the second workpiece. In most cases, the second workpiece only needs to be supported at the bottom side.

As already said before, the magnetic element according to the invention is arranged for being positioned between the surfaces of the workpieces that are to be welded together.

Preferably, the at least one magnet is a permanent magnet, which is preferably attached to the carrier, for example by glueing.

These permanent magnets can be made relatively thin and nevertheless have a large adhesive power. It is also possible to use other types of magnets, of course, such as electromagnets, if this should be possible or advantageous in a particular case.

The magnetisation direction of said at least one magnet preferably extends transversely to those surfaces of the magnetic element that will abut against the surfaces that are to be welded together. It is advantageous if an even number of magnets are used and said magnets are arranged in anti-parallel, which arrangement enables the largest possible holding power.

The carrier is preferably in the form of at least one plate of a magnetizable metal, to which said at least one magnet is attached, whilst two thin plates may be provided, between which said at least one magnet is positioned.

The invention will be explained in more detail hereinafter with reference to the drawings, which show an exemplary embodiment of the invention.

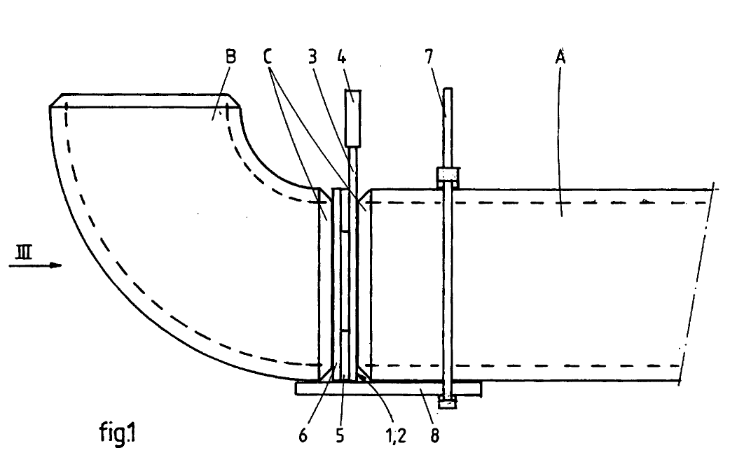

FIG. 1 is a side elevation of two pipe pieces with a magnetic element as well as a glueing clamp disposed therebetween.

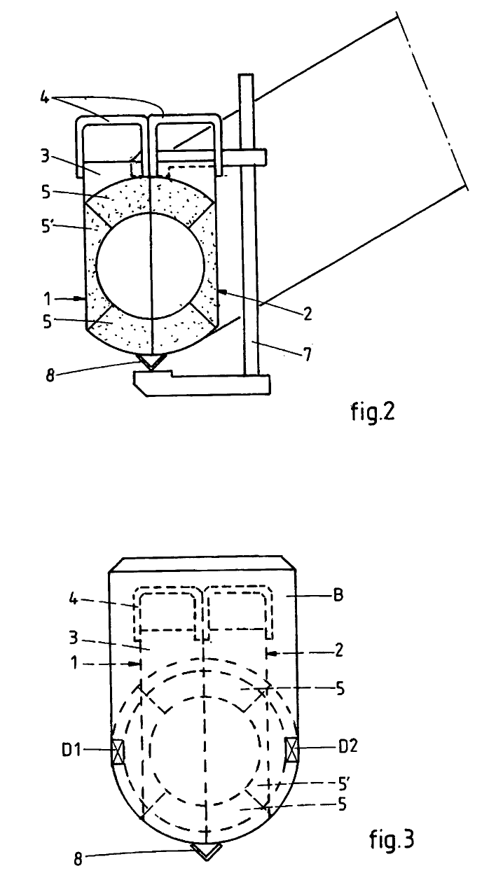

FIG. 2 is a front view of the magnetic element and the glueing clamp.

FIG. 3 is a view of the workpieces according to arrow III in FIG. 1, showing the workpieces after the two provisional welds have been provided.

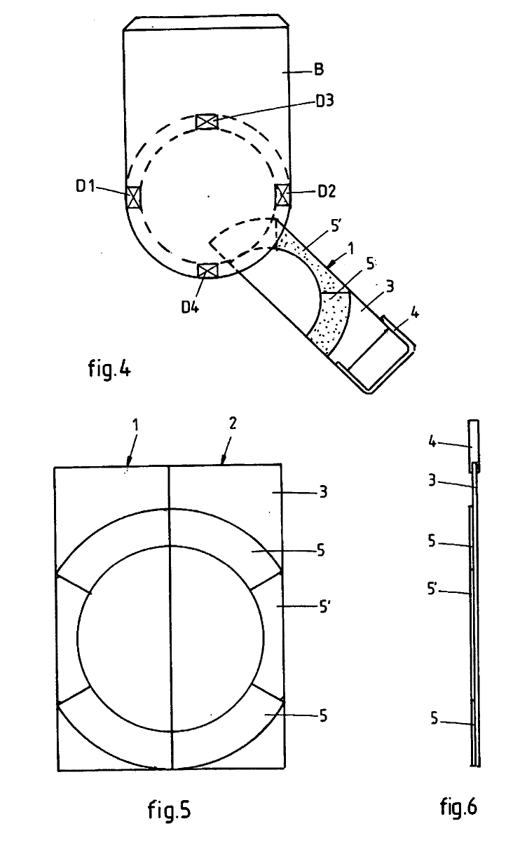

FIG. 4 is a view corresponding to FIG. 3, after a third provisional weld has been provided.

FIGS. 5 and 6 are a front view and a side view, respectively, of a part of the exemplary embodiment of the magnetic element according to the invention.

The drawing, and in particular FIGS. 1, 2, 5 and 6 show an embodiment of a magnetic element according to the invention which can be used in welding together workpieces, in this case pipe pieces. In the illustrated embodiment, a straight pipe piece A and a 90° bend B are used, whose end faces are to be welded together. To this end, a bevel C is formed on the end faces of pipe pieces A and B in order to form a V-joint which can be filled with welding material. The end faces of the pipe pieces A and B must not be placed into contact with each other, but an advance opening must be left clear. In the case of pipe pieces and the like, the dimension of this advance opening usually depends on the diameter of the pipes and the requirements of the customer/user.

This advance opening is used by the invention in that a magnetic element 1 is placed between the surfaces of the pipe pieces A and B that are to be welded together, by means of which magnetic element the pipe pieces can be positioned with respect to each other and which furthermore retains the pipe pieces in the correct position. In the illustrated embodiment, two magnetic strips 1 and 2 are used, which together form the magnetic element. Each magnetic strip 1, 2 is provided with a carrier 3, which is elongated, rectangular in shape in this embodiment, on one end of which a handle 4 is formed.

Each magnetic strip 1,2 includes a number of permanent magnets 5, 5′, with a total of a six magnets 5, 5′ being provided in this case, which are alternately connected and whose magnetization direction extends transversely to the main surface of the carrier 3. If permanent magnets are used, it is preferred to use an even number of magnets with alternately arranged poles.

The magnets 5, 5′ are attached to the magnetizable carrier 3 in some way or the other, for example by means of an industrial glue. Each magnet 5, 5′ is in the form of a circular segment, wherein the external diameter of the ring corresponds at least substantially to the external diameter of the end face of the pipe piece that is in contact with the magnetic strips 1, 2. The diameter thereof is smaller than the diameter of the pipe pieces A, B, because the end faces are bevelled. The internal diameter of the circular segments of the magnets 5, 5′, will generally be smaller than the internal diameter of the pipe pieces A and B.

As can be seen in the figures, the magnets 5′ are flattened on the outer side for the purpose of forming a recess, to such an extent that part of the surfaces of the pipe pieces A and B remains uncovered, which makes it possible to weld said surfaces together whilst the magnetic strips 1, 2 are present between the pipe pieces A and B. Preferably, the dimension of the recessed portion of the magnets 5′ is such that the internal diameter of the two pipe pieces A and B remains clear at that location, so that the pipe pieces A and B can be aligned on the basis of their internal diameter.

In the embodiment of the magnetic element that is shown in FIG. 1, a second plate 6 is furthermore provided, which is disposed on another side of the magnets 5, 5′ than the carrier 3, so that the magnets 5, 5′ are positioned between the carrier 3 and the plate 6. The composition of the magnetic strips 1,2 will depend in part on the desired thickness of the magnetic strips 1, 2, which in turn depends on the desired advance opening. Since the permanent magnets 5, 5′ must have a particular thickness in order to be able to generate sufficient magnetic power, the plate 6 will be left out in some cases.

The method according to the invention will now be explained in more detail by means of a specific exemplary embodiment.

The method that is shown in the drawings is as follows: first place an L-section 8 of 30×30×3 mm, which is welded to a glueing clamp 7, under the pipe pieces A and B. Now take the magnetic strips 1 and 2 and apply an anti-spattering spray thereto if electrical welding is going to be used.

Place the permanent magnetic strips 1 and 2 against the pipe piece A. Now place the bend B, for example, into contact with the magnetic strips 1 and 2 and move it to the correct position (FIGS. 1 and 2). The stainless steel strip that is also supplied can be used to check via the outer side whether it is properly centered. Centering can also take place on the inner side, if desired.

Slide a wedge between the V-joint formed by the edges C, at a location about 2 cm above the place where a first circular welding piece D1 is going to be welded in position. Insert the wedge about 5 mm by hitting it carefully, so that a little more space is created. This is done in order to be able to pull the magnetic strip out again after welding. Once the first circular welding piece D₁ is welded in place, the wedge can be pulled out. It is preferred to use argon gas welding, because this does not affect the magnetic field. Other welding methods are also possible, however.

The wedge must now be moved to the other side, where it can be inserted a little further. The bend B is supported on the L-section 8 and is welded in place on the other side. Now the second circular welding piece D₂ can be welded in position. Following that, the wedge can be removed.

The magnetic strip 2 can now be pulled from between the workpieces A and B.

Following that, the magnetic strip is moved a little further to the position where the magnetic strip 2 has been removed already. The opening is larger at this location and it is easier to pull out the magnetic strip 1 (FIG. 4).

Now the other two circular welding pieces D₃ and D₄ can be welded in place. First place the magnetic strip 1 between the workpieces A and B again, at a distance of 2-3 cm from where advanced welding is to take place. The workpieces A and B are magnetic at that location, so that the circular welding piece D₃ will remain in place. Weld it in place and repeat this procedure for the fourth circular welding piece D₄.

The pipe fitter has now completed his activities. The workpieces that have been joined provisionally are now taken to a welder, who makes the final weld. First, basic joints are provided between the circular welding pieces, for example by means of argon welding. Then the circular welding pieces are removed by grinding and the basic joint is completed. Finally, a final welded joint is provided on the basic joint. This can be done by normal electrical welding, using an electrode.

Usually, a different magnetic element is required for every pipe diameter (for example 1″-36″). The magnetic element is adapted in dependence on the diameter and the desired advance opening (for example 2½, 3¼, 4 or 5 mm), so that a set of magnetic elements is obtained.

From the foregoing it will be apparent that the invention provides a method and a magnetic element which enables a fitter to join heavier workpieces in an accurate manner all by himself.

The invention is not restricted to the exemplary embodiment as described above and shown in the drawing, which can be varied in several ways without departing from the scope of the appended claims. Thus, the magnetic element may have an altogether different shape, as long as it fits between the workpieces and leaves clear at least part of the surfaces to be welded. The magnetic elements may consist of one or more parts. Heavier workpieces (for example workpieces of more than 25 kg) will generally be hoisted in and be positioned by an adjustable support (gantry) at that location, so that the required magnetic force remains limited. Besides pipe pieces, pipe fittings and the like also all kinds of other workpieces can be joined together, such as T-pieces, flanges etc. It is not necessary for the advance opening to extend over the entire circumference of the workpieces.

1. A method for welding together a first and a second metal workpiece with an advance opening, comprising the following steps:
magnetising the first workpiece by contacting the first workpiece with a magnetic element,
positioning the second workpiece with respect to the first workpiece, such that the surfaces of the workpieces to be welded together will face each other,
welding together the said surfaces of the workpieces at least partially, and
removing the magnetic element,
characterized in that the magnetic element is placed between said surfaces of the first and the second workpiece, which are interconnected by welding, with the magnetic element only covering a part of said surfaces.

2. A method according to claim 1, characterized in that a provisional welded joint is formed between the first and the second workpiece after the second workpiece has been positioned with respect to the first workpiece, which magnetic element is removed before the final welded joint is formed.

3. A method according to claim 3, characterized in that the advance opening is widened before or after the provisional welded joint is made.

4. A method according to any one of the preceding claims, characterized in that at least one positioning element, such as a glueing clamp, is attached to the first workpiece temporarily before or after said magnetisation for the purpose of correctly positioning the second workpiece.

5. A method according to any one of the preceding claims, characterized in that at least two magnetic elements are used, one of which is removed after the provision of at least one, and preferably two, provisional welded joints, after which further provisional welded joints are made.

6. A method according to any one of the preceding claims, characterised in that the two workpieces are formed by a pipe piece and/or a pipe fitting.

7. A magnetic element to be used in welding together a first and a second workpiece with an advance opening, including a carrier comprising at least one magnet, characterised in that said magnetic element is arranged for being positioned between surfaces of the workpieces that are to be welded together.

8. A magnetic element according to claim 7, wherein the thickness of the magnetic element, at the location which, in use, will be positioned between the surfaces to be welded together, is at least substantially equal to, and preferably minimally smaller than, the dimension of the desired advance opening between the workpieces.

9. A magnetic element according to claim 7 or 8, wherein said at least one magnet is a permanent magnet, which is preferably attached to the carrier, for example by glueing.

10. A magnetic element according to any one of the claims 7-9, wherein the magnetisation direction of said at least one magnet extends transversely to those surfaces of the magnetic element that will abut against the surfaces that are to be welded together.

11. A magnetic element according to claim 10, wherein an even number of magnets used, and wherein the magnets are arranged in anti-parallel.

12. A magnetic element according to any one of the claims 7-11, wherein the carrier is at least one plate of a magnetisable metal, to which said at least one magnet is attached, preferably by glueing.

13. A magnetic element according to any one of the claims 7-12, wherein the carrier is provided with a handle.

14. A magnetic element according to any one of the claims 7-13, wherein the carrier is provided with at least one recess for releasing the surfaces to be welded together.

15. A magnetic element according to any one of the claims 7-13, which is intended for use as an auxiliary means in welding together pipe pieces/pipe fittings, wherein said at least one magnet is in the form of a(segment of a) circle.

16. A magnetic element according to any one of the claims 7-14, which is arranged for being placed between the workpieces together with a second magnetic element.

17. A set of magnetic elements according to any one of the claims 7-14, wherein each magnetic element has a different thickness and preferably also a different circumferential dimension
